(19) United States
(12) Patent Application Publication
(10) Pub. No.: US 2026/0058881 A1
(43) Pub. Date: Feb. 26, 2026

(54) COMMUNICATION METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/102,487

(22) PCT Filed: Aug. 11, 2022
(86) PCT No.: PCT/CN2022/111906

§ 371 Date: Feb. 10, 2025

(51) Int. Cl. H04L 41/16; H04W 72/23; H04W 74/0833

(52) U.S. Cl. CPC H04L 41/16; H04W 72/23; H04W 74/0833

(57) ABSTRACT

A communication method and apparatus, and a storage medium. The method comprises: in response to detecting a deterioration in the inference performance of an AI model during communication of a terminal in an AI mode, and when the inference performance of the AI model deteriorates to a level meeting a preset condition, switching to a non-AI mode to perform communication.

### CROSS-REFERENCE TO RELATED APPLICATIONS

The present application is a U.S. National Stage of International Application No. PCT/CN2022/111906, filed on Aug. 11, 2022, the disclosure of which is incorporated herein by reference in its entirety for all purposes.

### TECHNICAL FIELD

The present disclosure relates to the field of communication technology, and in particular to a communication method, apparatus and storage medium.

### BACKGROUND

With the development of communication technology, the widespread application of 5G technology has brought great changes to various aspects of people's lives. 5G technology will penetrate into various areas of the future society and build a comprehensive information ecosystem with users as the center. The 5G user experience rate can reach 100 Mbit/s˜1 Gbit/s, which can support extreme business experiences such as mobile virtual reality; the 5G peak rate can reach 10 Gbit/s˜20 Gbit/s, and the traffic density can reach 10 Mbit/s/m², which can support the growth of more than a thousand times of mobile business traffic in the future; the 5G connection density can reach 1 million/m², which can effectively support a huge number of Internet of Things (IOT) devices; the 5G transmission delay can reach milliseconds, which can meet the stringent requirements of vehicle networking and industrial control; 5G can support a mobile speed of 500 km/h, which can meet good user experience in high-speed rail environments. As a representative of new infrastructure, 5G will rebuild the future information society.

In recent years, artificial intelligence (AI) technology has made continuous breakthroughs in many fields. The continuous development of intelligent voice, computer vision and other fields has not only brought a variety of applications for smart terminals, but also been widely used in education, transportation, home, medical care, retail, security and other fields, bringing convenience to people's lives while promoting industrial upgrading in various industries. The AI technology is also accelerating its cross-penetration with other disciplines, and while its development integrates knowledge from different disciplines, it also provides new directions and methods for the development of different disciplines.

### SUMMARY

According to a first aspect of embodiments of the present disclosure, a communication method is provided, which is applied to a terminal, and the method includes: in response to monitoring that inference performance of an artificial intelligence (AI) model decreases during communication of a terminal in an AI mode and the inference performance of the AI model decreases to meet a preset condition, switching to a non-AI mode for communication.

According to a second aspect of embodiments of the present disclosure, a communication method is provided, which is applied to a network device, and the method includes: in response to monitoring that inference performance of an artificial intelligence (AI) model in a radio air interface decreases, and the inference performance of the AI model decreases to meet a preset condition, sending a switching indication, where the switching indication is used to indicate a terminal to switch from communication in an AI mode to communication in a non-AI mode.

According to a third aspect of embodiments of the present disclosure, a communication method is provided, which is applied to a network device, and the method includes: receiving a switching request sent by a terminal, where the switching request is triggered by the terminal in a case where the terminal monitors that inference performance of an artificial intelligence (AI) model during communication of the terminal in an AI model decreases and the inference performance of the AI model decreases to meet a preset condition, and the switching request is used to request switching to a non-AI mode for communication.

According to a fourth aspect of embodiments of the present disclosure, a communication method is provided, the method including: receiving a switching indication, where the switching indication is sent by a network device in a case where the network device monitors decrease of inference performance of an artificial intelligence (AI) model in a radio air interface and the inference performance of the AI model decreases to meet a preset condition, and the switching indication is used to indicate the terminal to switch from communication in an AI mode to communication in a non-AI mode.

According to a fifth aspect of embodiments of the present disclosure, a communication apparatus is provided, the apparatus including: a switching module configured to switch to a non-artificial intelligence (AI) mode for communication in response to monitoring that inference performance of an AI model decreases during communication of a terminal in an AI mode and the inference performance of the AI model decreases to meet a preset condition.

According to a sixth aspect of embodiments of the present disclosure, a communication apparatus is provided, the apparatus including: a sending module configured to send a switching indication in response to monitoring that inference performance of an artificial intelligence (AI) model in a radio air interface decreases and the inference performance of the AI model decreases to meet a preset condition, where the switching indication is used to indicate the terminal to switch from communication in an AI mode to communication in a non-AI mode.

According to a seventh aspect of embodiments of the present disclosure, a communication apparatus is provided, the apparatus including: a receiving module, configured to receive a switching request sent by a terminal, where the switching request is triggered by the terminal in a case where the terminal monitors that inference performance of an artificial intelligence (AI) model decreases during communication of the terminal in an AI mode and the inference performance of the AI model decreases to meet a preset condition, and the switching request is used to request switching to a non-AI mode for communication.

According to an eighth aspect of embodiments of the present disclosure, a communication apparatus is provided, the apparatus including: a receiving module, configured to receive a switching indication, where the switching indication is sent by a network device in a case where the network device monitors that inference performance of an artificial intelligence (AI) model in a radio air interface decreases and the inference performance of the AI model decreases to meet a preset condition, and the switching indication is used to indicate the terminal to switch from communication in an AI mode to communication in a non-AI mode.

According to a ninth aspect of embodiments of the present disclosure, a communication apparatus is provided, the apparatus including: a processor; and a memory configured to store instructions executable by the processor; where the processor is configured to execute the communication method described in any of the above first aspect and one of the implementations thereof, or execute the communication method described in any of the above second aspect and one of the implementations thereof, or execute the communication method described in any of the above third aspect and one of the implementations thereof, or execute the communication method described in any of the above fourth aspect and one of the implementations thereof.

According to a tenth aspect of embodiments of the present disclosure, there is provided a storage medium having stored thereon instructions which, when being executed by a processor of a terminal, cause the terminal to execute the communication method described in any of the above first aspect and one of the implementations thereof, or when being executed by a processor of a network device, cause the network device to execute the communication method described in any of the above second aspect and one of the implementations thereof, or when being executed by a processor of a network device, cause the network device to execute the communication method described in any of the above third aspect and one of the implementations thereof, or when being executed by a processor of a terminal, cause the terminal to execute the communication method described in any of the above fourth aspect and one of the implementations thereof.

It is to be understood that the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram showing a wireless communication system according to an illustrative embodiment.

FIG. 2 is a flow chart showing a communication method according to an illustrative embodiment.

FIG. 3 is a flow chart showing a communication method according to an illustrative embodiment.

FIG. 4 is a flow chart showing a communication method according to an illustrative embodiment.

FIG. 5 is a flow chart showing a communication method according to an illustrative embodiment.

FIG. 6 is a flow chart showing a communication method according to an illustrative embodiment.

FIG. 7 is a flow chart showing a communication method according to an illustrative embodiment.

FIG. 8 is a flow chart showing a communication method according to an illustrative embodiment.

FIG. 9 is a flow chart showing a communication method according to an illustrative embodiment.

FIG. 10 is a flowchart showing a communication method according to an illustrative embodiment.

FIG. 11 is a flowchart showing a communication method according to an illustrative embodiment.

FIG. 12 is a flow chart showing a communication method according to an illustrative embodiment.

FIG. 13 is a flow chart showing a communication method according to an illustrative embodiment.

FIG. 14 is a flow chart showing a communication method according to an illustrative embodiment.

FIG. 15 is a block diagram showing a communication apparatus according to an illustrative embodiment.

FIG. 16 is a block diagram showing a communication apparatus according to an illustrative embodiment.

FIG. 17 is a block diagram showing a communication apparatus according to an illustrative embodiment.

FIG. 18 is a block diagram showing a communication apparatus according to an illustrative embodiment.

FIG. 19 is a block diagram showing a communication apparatus according to an illustrative embodiment.

FIG. 20 is a block diagram showing a communication apparatus according to an illustrative embodiment.

### DETAILED DESCRIPTION

Herein, illustrative embodiments will be described in detail, examples of which are shown in the accompanying drawings. When the following description refers to the drawings, unless otherwise indicated, the same numbers in different drawings represent the same or similar elements. The implementations described in the following illustrative embodiments do not represent all implementations consistent with the present disclosure.

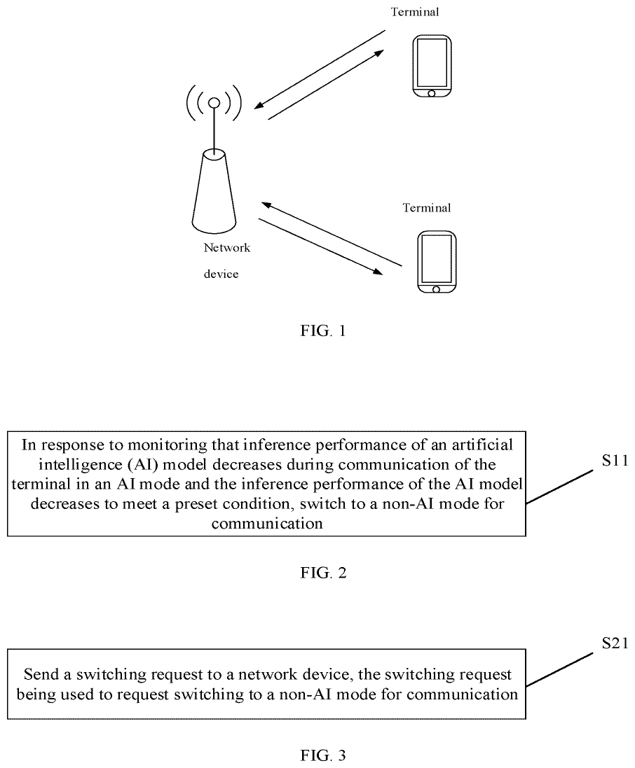

A communication method provided by an embodiment of the present disclosure can be applied to a wireless communication system as shown in FIG. 1. As shown in FIG. 1, the wireless communication system includes a network device and a terminal. The terminal is connected to the network device through wireless resources and performs data transmission.

It can be understood that the wireless communication system shown in FIG. 1 is only for schematic illustration, and the wireless communication system may also include other network devices, such as a core network device, a wireless relay device, a wireless backhaul device or the like, which are not shown in FIG. 1. The embodiments of the present disclosure do not restrict the number of network devices and terminals included in the wireless communication system.

It can be further understood that the wireless communication system of the embodiments of the present disclosure is a network that provides wireless communication functions. The wireless communication system can adopt different communication technologies, such as code division multiple access (CDMA), wideband code division multiple access (WCDMA), time division multiple access (TDMA), frequency division multiple access (FDMA), orthogonal frequency division multiple access (OFDMA), single carrier frequency division multiple access (single Carrier FDMA, SC-FDMA), or Carrier Sense Multiple Access with Collision Avoidance. Depending on capacity, rates, delay and other factors of different networks, the network can be divided into 2th generation (2G) network, 3G network, 4G network or future evolution network, such as 5G network. 5G network can also be called New Radio (NR). For the convenience of description, the present disclosure sometimes refers to the wireless communication network simply as a network.

Further, the network device involved in the present disclosure may also be referred to as a wireless access network device. The wireless access network device may be a base station, an evolved node B, a home base station, an access point (AP) in a wireless fidelity (WIFI) system, a wireless relay node, a wireless backhaul node, a transmission point (TP) or a transmission and reception point (TRP), etc. It may also be a gNB in an NR system, or it may also be a component or part of a device that constitutes the base station. It should be understood that in the embodiments of the present disclosure, the specific technology and specific device form adopted by the network device are not limited. In the present disclosure, the network device may provide communication coverage for a specific geographical area, and may communicate with a terminal located in the coverage area (cell). In addition, in a case of a vehicle-to-everything (V2X) communication system, the network device may also be a vehicle-mounted device.

Furthermore, the terminal involved in the present disclosure may also be referred to as a terminal device, a user equipment (UE), a mobile station (MS), a mobile terminal (MT), etc., which is a device that provides voice and/or data connectivity to users. For example, the terminal may be a handheld device, a vehicle-mounted device, etc. that has a wireless connection function. At present, some examples of the terminal includes: a smart phone (Mobile Phone), a Customer Premise Equipment (CPE), a Pocket Personal Computer (PPC), a handheld computer, a personal digital assistant (PDA), a notebook computer, a tablet computer, a wearable device, or a vehicle-mounted device, etc. In addition, in a case of a vehicle-to-everything (V2X) communication system, the terminal device may also be a vehicle-mounted device. It should be understood that the embodiments of the present disclosure do not limit the specific technology and specific device form adopted by the terminal.

In recent years, artificial intelligence (AI) technology has made continuous breakthroughs in many fields. The continuous development of intelligent voice, computer vision and other fields has not only brought a variety of applications for smart terminals, but also been widely used in education, transportation, home, medical care, retail, security and other fields, bringing convenience to people's lives while promoting industrial upgrading in various industries. The AI technology is also accelerating its cross-penetration with other disciplines, and while its development integrates knowledge from different disciplines, it also provides new directions and methods for the development of different disciplines.

In the related art, a research project on AI technology in the radio air interface is established in the Radio Access Network (RAN) to introduce artificial intelligence technology in the radio air interface and assist in improving the transmission technology of the radio air interface. In addition, it currently supports the application of AI technology in the radio air interface for communication processing, including the training of AI models and the inference application of models. However, the radio communication environment of the radio air interface changes in real time, which will affect the inference performance of AI in the radio air interface.

In view of the above problems, an embodiment of the present disclosure provides a communication method, which switches to traditional non-AI mode communication when the inference performance of the AI model decreases sharply so as to avoid that the communication performance is affected.

FIG. 2 is a flow chart showing a communication method according to an illustrative embodiment. As shown in FIG. 2, the communication method is used in a terminal and includes the following steps.

In step S11, in response to monitoring that inference performance of an artificial intelligence (AI) model decreases during communication of the terminal in an AI mode and the inference performance of the AI model decreases to meet a preset condition, it switches to a non-AI mode for communication.

In an embodiment of the present disclosure, in a case where the terminal monitors that the AI model inference performance decreases when the terminal performs communication in the artificial intelligence (AI) mode, and the inference performance of the AI model decreases to meet the preset conditions, it indicates that the communication performance of the terminal in the AI mode may no longer meet the demand, and in this case, the terminal needs to switch to the non-AI mode to avoid that the communication performance of the terminal is affected.

In an implementation of the communication method provided in an embodiment of the present disclosure, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

The preset performance condition may be that a system throughput of the inference object is lower than a system throughput threshold, a Central Processing Unit (CPU) occupancy rate is higher than a CPU occupancy rate threshold, etc., which are not specifically limited in the embodiments of the present disclosure.

In an example, in a case where the terminal detects that the AI model inference performance decreases when the terminal performs communication in the artificial intelligence AI mode, and the AI model inference performance decreases to the extent that the system throughput of the inference object applying the AI model is lower than the system throughput threshold, it switches to the non-AI mode for communication.

FIG. 3 is a flow chart of a communication method according to an illustrative embodiment. As shown in FIG. 3, the communication method is used in a terminal and includes the following steps.

In step S21, a switching request is sent to a network device, where the switching request is used to request switching to a non-AI mode for communication.

In an embodiment of the present disclosure, the terminal sends the switching request to the network device, so that the network device can switch to the non-AI mode for communication according to the switching request, thereby avoiding that the communication performance of the network device is affected.

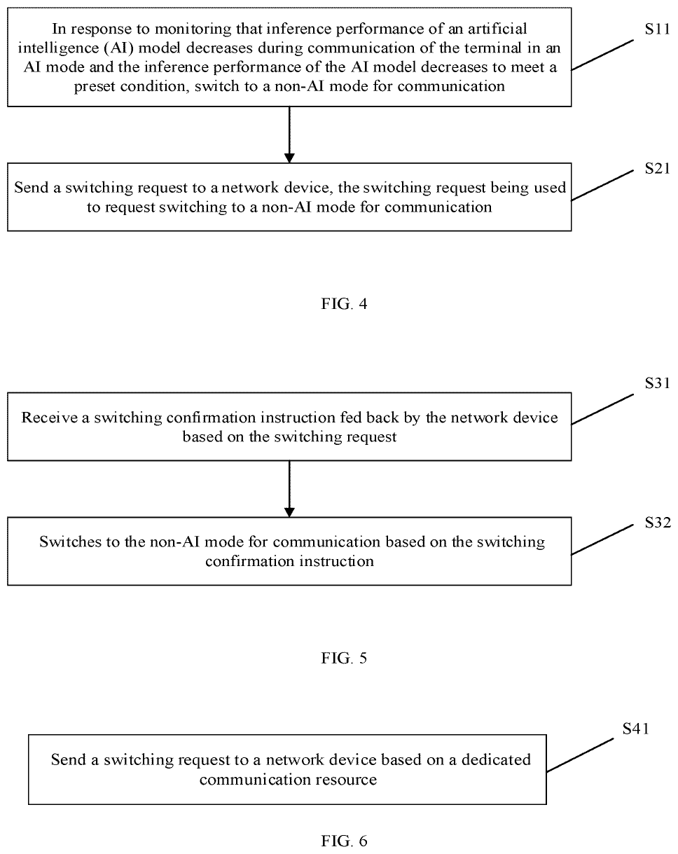

FIG. 4 is a flow chart showing a communication method according to an illustrative embodiment. As shown in FIG. 4, the method includes the following steps.

In step S11, in response to monitoring that inference performance of an artificial intelligence (AI) model decreases during communication of the terminal in an AI mode, and the inference performance of the AI model decreases to meet a preset condition, it switches to a non-AI mode for communication.

In step S21, a switching request is sent to a network device, where the switching request is used to request switching to the non-AI mode for communication.

In an embodiment of the present disclosure, in a case where the terminal detects that the inference performance of the artificial intelligence (AI) model decreases when the terminal performs communication in the AI mode, and the inference performance of the AI model decreases to meet the preset condition, the terminal switches to the non-AI mode for communication, and sends the switching request to the network device at the same time, so that the network device switches to the non-AI mode for communication, thereby avoiding that the communication performance of the terminal and the network device is affected.

In an implementation of the communication method provided in the embodiment of the present disclosure, as shown in FIG. 5, a flow chart of a method for switching to the AI mode for communication is shown, including the following steps.

In step S31, a switching confirmation instruction fed back by the network device based on the switching request is received.

In step S32, based on the switching confirmation instruction, it switches to the non-AI mode for communication.

In an implementation of the communication method provided in an embodiment of the present disclosure, in response to receiving the switching confirmation instruction sent by a network device, it switches to the non-AI mode for communication.

In another implementation of the communication method provided in the embodiment of the present disclosure, after a set time unit from receipt of the switching confirmation instruction sent by the network device, it switches to the non-AI mode for communication.

In an embodiment of the present disclosure, in order to ensure synchronous switching between the terminal and the network device, after a set time unit from receipt of the switching confirmation instruction sent by the network device, it switches to the non-AI mode for communication.

FIG. 6 is a flow chart showing a communication method according to an illustrative embodiment. As shown in FIG. 6, the method includes the following steps.

In step S41, a switching request is sent to a network device based on a dedicated communication resource.

The dedicated communication resource is a communication resource dedicated to requesting to switch from the AI mode to the non-AI mode for communication.

In an implementation of the communication method provided in the embodiment of the present disclosure, the dedicated communication resource includes a physical random access channel (PRACH) resource dedicated to mode switching.

In an implementation of the communication method provided in the embodiment of the present disclosure, a two-step random access method or a four-step random access method is adopted to send the switching request to the network device based on the PRACH resource.

The four-step random access method includes: 1, the terminal sends a random access preamble code (MSG1) to the network device in the PRACH to inform the network device that there is a random access request; 2, a random access response (MSG2) is transmitted on a downlink shared channel; 3, the terminal transmits information of first uplink transmission (MSG3) on a uplink shared channel; and 4, the network device transmits contention resolution information (MSG4) on the downlink shared channel.

The two-step random access method combines the preamble (MSG 1) and the scheduled PUSCH transmission (MSG3) into a single message (MSGA) from the UE, called MSGA. The random access response (MSG2) and the contention resolution message (MSG4) are combined into a single message (MSGB) from the network device to the terminal.

Hereinafter, MASG2 is also referred to as message 2, MSG4 is also referred to as message 4, and MSGB is also referred to as message B.

In an implementation of the communication method provided by the embodiment of the present disclosure, in response to that the switching request is sent using the two-step random access method, the switching confirmation instruction fed back by the network device based on the switching request is received based on a physical downlink control channel (PDCCH) or a physical downlink shared channel (PDSCH) corresponding to message B.

In another implementation of the communication method provided by the embodiment of the present disclosure, in response to that the switching request is sent using the four-step random access method, the switching confirmation instruction fed back by the network device based on the switching request is received based on the physical downlink control channel (PDCCH) or the physical downlink shared channel (PDSCH) corresponding to message 2 or message 4.

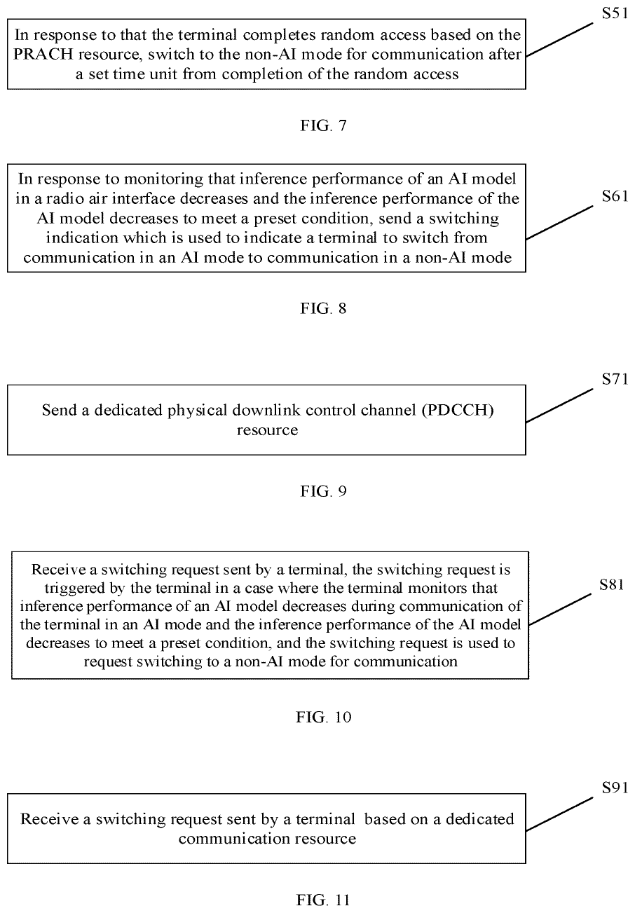

In an implementation of the communication method provided in the embodiment of the present disclosure, as shown in FIG. 7, a flow chart of a method for switching to the AI mode for communication is shown, including the following steps.

In step S51, in response to that the terminal completes random access based on the PRACH resource, after a set time unit from completion of the random access, it switches to the non-AI mode for communication.

In the embodiment of the present disclosure, after the set time unit since the terminal completes the random access based on the PRACH resource, the terminal switches to the AI mode for communication, thereby ensuring that the terminal and the network device achieve synchronous switching.

In another implementation of the communication method provided in the embodiment of the present disclosure, the dedicated communication resource includes a physical uplink control channel (PUCCH) resource dedicated to mode switching by the terminal.

In an implementation of the communication method provided by the embodiment of the present disclosure, the switching confirmation instruction fed back by the network device based on the switching request is received based on a physical downlink control channel (PDCCH).

In an implementation of the communication method provided in the embodiment of the present disclosure, in response to that the terminal completes PUCCH transmission based on the PUCCH resource, after a set time unit from completion of the PUCCH transmission, it switches to the non-AI mode for communication.

In the embodiment of the present disclosure, after the set time unit since the terminal completes the PUCCH transmission based on the PUCCH resource, the terminal switches to the AI mode for communication, thereby ensuring synchronous switching between the terminal and the network device.

FIG. 8 is a flow chart showing a communication method according to an illustrative embodiment. As shown in FIG. 8, the communication method is used in a network device and includes the following steps.

In step S61, in response to monitoring that inference performance of an artificial intelligence (AI) model in a radio air interface decreases, and the inference performance of the AI model decreases to meet a preset condition, a switching indication is sent, and the switching indication is used to indicate a terminal to switch from communication in an AI mode to communication in a non-AI mode.

In an embodiment of the present disclosure, in a case where the network device detects that the inference performance of the artificial intelligence (AI) model in the radio air interface decreases and the inference performance of the AI model decreases to meet the preset condition, the terminal is instructed to switch to the non-AI mode for communication, thereby avoiding that the communication performance of the network device and the terminal is affected.

In an implementation of the communication method provided in an embodiment of the present disclosure, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

The preset performance condition may be that a system throughput of the inference object is lower than a system throughput threshold, a CPU occupancy rate is higher than a CPU occupancy rate threshold, etc., which are not specifically limited in the embodiments of the present disclosure. In the embodiment of the present disclosure, the terminal applies the AI model, and the network device monitors the inference performance of the AI model.

In an implementation of the communication method provided in an embodiment of the present disclosure, as shown in FIG. 9, a flow chart of a method for sending a switching indication is shown, including the following steps.

In step S71, a dedicated physical downlink control channel (PDCCH) resource is sent.

The dedicated PDCCH resource is used to indicate the terminal to switch from communication in an AI mode to communication in a non-AI mode.

In an implementation of the communication method provided by the embodiment of the present disclosure, the dedicated physical downlink control channel resource includes a unicast PDCCH corresponding to the terminal.

In another implementation of the communication method provided by the embodiment of the present disclosure, the dedicated physical downlink control channel resources include a general PDCCH group, and the PDCCH group includes multiple information indication fields for indicating multiple terminals to switch from communication in the AI mode to communication in the non-AI mode.

In an example, the PDCCH group includes a first terminal and a second terminal, the information indication field for the first terminal corresponds to a first bit, and the information indication field for the second terminal corresponds to a second bit. If the first bit is 0, the first terminal switches from communication in the AI mode to communication in the non-AI mode, and if the second bit is 1, the second terminal does not switch from communication in the AI mode to communication in the non-AI mode, and maintains the AI mode for communication.

In addition to the above embodiments, when the application of the AI model and monitoring of the inference performance are both performed by the network device, the AI model is in a closed-loop state, the network device itself performs application and monitoring, and the AI model is not applied in the terminal. Therefore, the communication of the terminal is not affected by the inference performance of the AI model. In this case, when the network device monitors that the inference performance of the artificial intelligence (AI) model in the radio air interface decreases and the inference performance of the AI model decreases to meet the preset condition, it needs not to send a switching instruction to the terminal, and the network device itself can perform switching.

FIG. 10 is a flow chart showing a communication method according to an illustrative embodiment. As shown in FIG. 10, the communication method is used in a network device and includes the following steps.

In step S81, a switching request sent by a terminal is received. The switching request is triggered by the terminal in a case where the terminal monitors that inference performance of an artificial intelligence (AI) model decreases during communication of the terminal in an AI mode and the inference performance of the AI model decreases to meet a preset condition, and the switching request is used to request switching to a non-AI mode for communication.

In an implementation of the communication method provided in the embodiment of the present disclosure, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition. In an implementation of the communication method provided in the embodiment of the present disclosure, as shown in FIG. 11, a flow chart of a method for receiving a switching indication is shown, including the following steps.

In step S91, a switching request sent by a terminal is received based on a dedicated communication resource.

The dedicated communication resource is a communication resource dedicated to requesting to switch from an AI mode to a non-AI mode for communication.

In an implementation of the communication method provided in the embodiment of the present disclosure, the dedicated communication resource includes a physical random access channel (PRACH) resource dedicated to mode switching.

In an implementation of the communication method provided in the embodiment of the present disclosure, a two-step random access method or a four-step random access method is adopted to receive the switching request sent by the terminal based on the PRACH resource.

In another implementation of the communication method provided in the embodiment of the present disclosure, the dedicated communication resource includes a physical uplink control channel (PUCCH) resource dedicated to mode switching by the terminal.

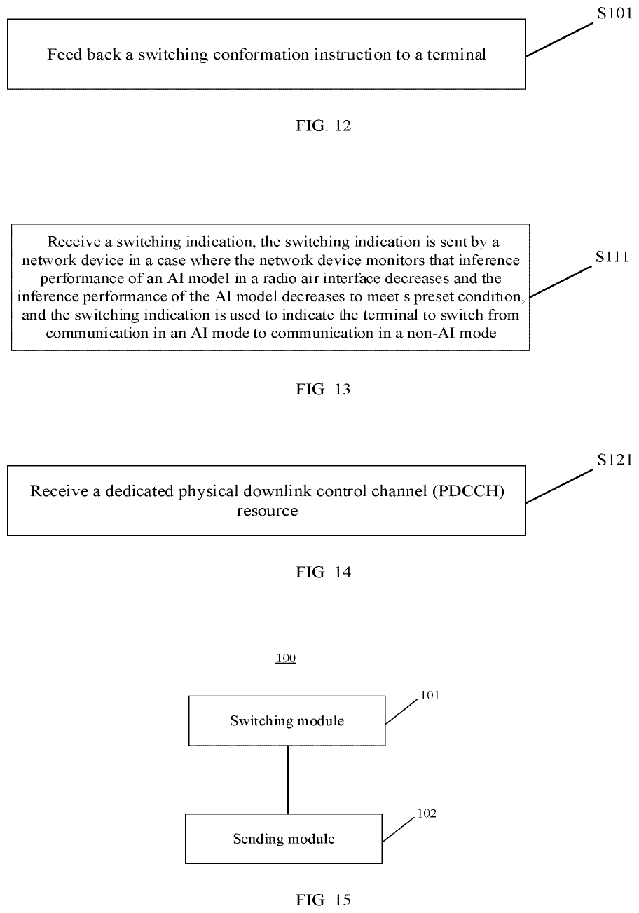

FIG. 12 is a flow chart of a communication method according to an illustrative embodiment. As shown in FIG. 12, the method includes the following steps.

In step S101, a switching conformation instruction is fed back to a terminal.

In an implementation of the communication method provided in the embodiment of the present disclosure, in response to that the switching request is sent using the two-step random access method, the switching conformation instruction is fed back to the terminal based on a physical downlink control channel (PDCCH) or a physical downlink shared channel (PDSCH) corresponding to message B.

In another implementation of the communication method provided by the embodiment of the present disclosure, in response to that the switching request is sent using the four-step random access method, the switching conformation instruction is fed back to the terminal based on a physical downlink control channel (PDCCH) or a physical downlink shared channel (PDSCH) corresponding to message 2 or message 4.

In another implementation of the communication method provided by the embodiment of the present disclosure, in response to that the switching request is sent based on the PUCCH resource, the switching conformation instruction is fed back to the terminal based on a physical downlink control channel (PDCCH).

In the embodiment of the present disclosure, after receiving the switching request sent by the terminal, the network device feeds back the switching confirmation instruction to the terminal to ensure that the terminal and the network device achieve synchronous switching.

FIG. 13 is a flow chart of a communication method according to an illustrative embodiment. As shown in FIG. 13, the communication method is used in a terminal and includes the following steps.

In step S111, a switching indication is received. The switching indication is sent by a network device in a case where the network device monitors that inference performance of an artificial intelligence (AI) model in a radio air interface decreases and the inference performance of the AI model decreases to meet s preset condition, and the switching indication is used to indicate the terminal to switch from communication in an AI mode to communication in a non-AI mode.

In an implementation of the communication method provided in an embodiment of the present disclosure, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

In an implementation of a communication method provided in an embodiment of the present disclosure, as shown in FIG. 14, a flow chart of a method for receiving a switching indication is shown, including the following steps.

In step S121, a dedicated physical downlink control channel (PDCCH) resource is received.

The dedicated PDCCH resource is used to indicate the terminal to switch from communication in an AI mode to communication in a non-AI mode.

In an implementation of the communication method provided by the embodiment of the present disclosure, the dedicated physical downlink control channel resource includes a unicast PDCCH corresponding to the terminal.

In another implementation of the communication method provided by the embodiment of the present disclosure, the dedicated physical downlink control channel resource includes a general PDCCH group, and the PDCCH group includes multiple information indication fields for indicating multiple terminals to switch from communication in the AI mode to communication in the non-AI mode.

In the embodiment of the present disclosure, after receiving the switching instruction sent by the network device, the terminal switches from communication in the AI mode to communication in the non-AI mode, thereby ensuring that the performance of the radio air interface is not affected.

The communication method provided in the present disclosure is applicable to a process of realizing communication through interaction between a terminal and a network device. In the method of realizing communication through interaction between the terminal and the network device, the terminal and the network device each has relevant functions of implementing the communication method involved in the above embodiments, which will not be repeated here.

It should be noted that those skilled in the art can understand that the various implementations/embodiments involved in the embodiments of the present disclosure can be used in conjunction with the aforementioned embodiments or can be used independently. Whether used alone or in conjunction with the aforementioned embodiments, the implementation principle is similar. In the embodiments of the present disclosure, some embodiments are described in terms of implementations used together. Of course, those skilled in the art can understand that such examples are not limitations on the embodiments of the present disclosure.

Based on the same concept, the embodiments of the present disclosure also provide a communication apparatus.

It can be understood that in order to implement the above functions, the communication apparatus provided by the embodiments of the present disclosure includes a hardware structure and/or software modules corresponding to the functions. In combination with units and algorithm steps of the examples disclosed in the embodiments of the present disclosure, the embodiments of the present disclosure can be implemented in the form of hardware or a combination of hardware and computer software. Whether a function is executed in the form of hardware or computer software driving hardware depends on the specific application and design constraints of the technical solution. Those skilled in the art can use different methods to implement the described functions for each specific application, and such implementations should not be considered as going beyond the scope of the technical solution of the embodiments of the present disclosure.

FIG. 15 is a block diagram of a communication apparatus according to an illustrative embodiment. Referring to FIG. 15, the apparatus 100 includes a switching module 101 and a sending module 102.

The switching module 101 is configured to, in response to monitoring that inference performance of an artificial intelligence (AI) model decreases during communication of the terminal in an AI mode and the inference performance of the AI model decreases to meet a preset condition, switch to a non-AI mode for communication.

In an implementation, the sending module 102 is configured to send a switching request to the network device, where the switching request is used to request switching to the non-AI mode for communication.

In an implementation, the switching module 101 is specifically configured to receive a switching confirmation instruction fed back by the network device based on the switching request; and switch to the non-AI mode for communication based on the switching confirmation instruction.

In an implementation, the switching module 101 is further configured to switch to the non-AI mode for communication in response to receiving the switching confirmation instruction sent by the network device.

In an implementation, the switching module 101 is further configured to switch to the non-AI mode for communication after a set time unit from receipt of the switching confirmation instruction sent by the network device.

In an implementation, the sending module 102 is specifically configured to send the switching request to the network device based on a dedicated communication resource, where the dedicated communication resource is a communication resource dedicated to requesting switching from the AI mode to the non-AI mode for communication.

In an implementation, the dedicated communication resource includes a physical random access channel (PRACH) resource dedicated to mode switching.

In an implementation, the sending module 102 is further configured to send the switching request to the network device based on the PRACH resource by using a two-step random access method or a four-step random access method.

In an implementation, in response to that the switching request is sent using the two-step random access method, the switching confirmation instruction fed back by the network device based on the switching request is received based on a physical downlink control channel (PDCCH) or a physical downlink shared channel (PDSCH) corresponding to message B; or, in response to that the switching request is sent using the four-step random access method, the switching confirmation instruction fed back by the network device based on the switching request is received based on a physical downlink control channel (PDCCH) or a physical downlink shared channel (PDSCH) corresponding to message 2 or message 4.

In an implementation, the switching module 101 is further configured to, in response to that the terminal completes random access based on the PRACH resource, switch to the non-AI mode for communication after a set time unit from completion of the random access.

In an implementation, the dedicated communication resource includes a physical uplink control channel (PUCCH) resource dedicated to mode switching by the terminal.

In an implementation, the switching confirmation instruction fed back by the network device based on the switching request is received based on a physical downlink control channel (PDCCH).

In an implementation, the switching module 101 is further configured to, in response to that the terminal completes PUCCH transmission based on the PUCCH resource, switch to the non-AI mode for communication after a set time unit from completion of the PUCCH transmission.

In an implementation, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

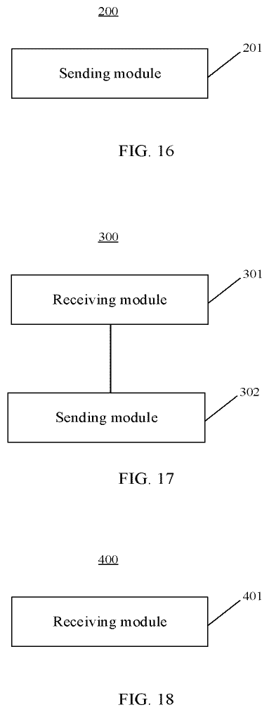

FIG. 16 is a block diagram of a communication apparatus according to an illustrative embodiment. Referring to FIG. 16, the apparatus 200 includes a sending module 201.

The sending module 201 is configured to send a switching indication in response to monitoring that inference performance of an artificial intelligence (AI) model in a radio air interface decreases and the inference performance of the AI model decreases to meet a preset condition, where the switching indication is used to indicate a terminal to switch from communication in an AI mode to communication in a non-AI mode.

In an implementation, the sending module 201 is specifically configured to send a dedicated physical downlink control channel (PDCCH) resource, where the dedicated PDCCH resource is used to indicate the terminal to switch from communication in the AI mode to communication in the non-AI mode.

In an implementation, the dedicated physical downlink control channel resource includes a unicast PDCCH corresponding to the terminal.

In an implementation, the dedicated physical downlink control channel resource includes a general PDCCH group, and the PDCCH group includes multiple information indication fields for indicating multiple terminals to switch from communication in the AI mode to communication in the non-AI mode.

In an embodiment, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

FIG. 17 is a block diagram of a communication apparatus according to an illustrative embodiment. Referring to FIG. 17, the apparatus 300 includes a receiving module 301 and a sending module 302.

The receiving module 301 is used to receive a switching request sent by a terminal. The switching request is triggered by the terminal in a case where the terminal monitors that inference performance of an artificial intelligence (AI) model decreases during communication of the terminal in an AI mode, and the inference performance of the AI model decreases to meet a preset condition, and the switching request is used to request switching to a non-AI mode for communication.

In an implementation, the receiving module 301 is further configured to receive the switching request sent by the terminal based on a dedicated communication resource, where the dedicated communication resource is a communication resource dedicated to requesting switching from the AI mode to the non-AI mode for communication.

In an implementation, the dedicated communication resource includes a physical random access channel (PRACH) resource dedicated to mode switching.

In an implementation, the receiving module 301 is further configured to receive the switching request sent by the terminal based on the PRACH resource using a two-step random access method or a four-step random access method.

In an implementation, the dedicated communication resource includes a physical uplink control channel (PUCCH) resource dedicated to mode switching by the terminal.

In an implementation, the sending module 302 is configured to feed back a switching confirmation instruction to the terminal.

In an implementation, in response to that the switching request is sent using the two-step random access method, the switching confirmation instruction is fed back to the terminal based on a physical downlink control channel (PDCCH) or a physical downlink shared channel (PDSCH) corresponding to message B; or, in response to that the switching request is sent using the four-step random access method, the switching confirmation instruction is fed back to the terminal based on a physical downlink control channel (PDCCH) or a physical downlink shared channel (PDSCH) corresponding to message 2 or message 4.

In an implementation, the sending module 302 is specifically configured to, in response to that the switching request is sent based on the PUCCH resource, feed back the switching confirmation instruction to the terminal based on the physical downlink control channel (PDCCH).

In an implementation, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

FIG. 18 is a block diagram of a communication apparatus according to an illustrative embodiment. Referring to FIG. 18, the apparatus 400 includes a receiving module 401.

The receiving module 401 is configured to receive a switching indication, the switching indication is sent by a network device in a case where the network device monitors that inference performance of an artificial intelligence (AI) model in a radio air interface decreases and the inference performance of the AI model decreases to meet a preset condition, and the switching indication is used to indicate the terminal to switch from communication in an AI mode to communication in a non-AI mode.

In an implementation, the receiving module 401 is specifically configured to receive a dedicated physical downlink control channel (PDCCH) resource, and the dedicated PDCCH resource is used to indicate the terminal to switch from communication in the AI mode to communication in the non-AI mode.

In an implementation, the dedicated physical downlink control channel resource includes a unicast PDCCH corresponding to the terminal.

In an implementation, the dedicated physical downlink control channel resource includes a general PDCCH group, and the PDCCH group includes multiple information indication fields for instructing multiple terminals to switch from communication in the AI mode to communication in the non-AI mode.

In an embodiment, the preset condition includes at least one of the following conditions: a rate of decrease of the inference performance of the AI model exceeds a rate threshold; an accuracy of the inference performance of the AI model is lower than an accuracy threshold; or an operating performance of an inference object applying the AI model meets a preset performance condition.

Regarding the apparatuses in the above embodiments, the specific manner in which the module performs operations has been described in detail in the method embodiments, which will not be repeated here.

The technical solution provided by the embodiments of the present disclosure can include the following beneficial effects. When the terminal monitors that the inference performance of the artificial intelligence (AI) model decreases during communication of the terminal in the AI mode or when the network device monitors that the inference performance of the artificial intelligence (AI) model in the radio air interface decreases, and the inference performance of the AI model decreases to meet the preset condition, it switches to the non-AI mode for communication, thereby avoiding that the communication performance of the terminal is affected.

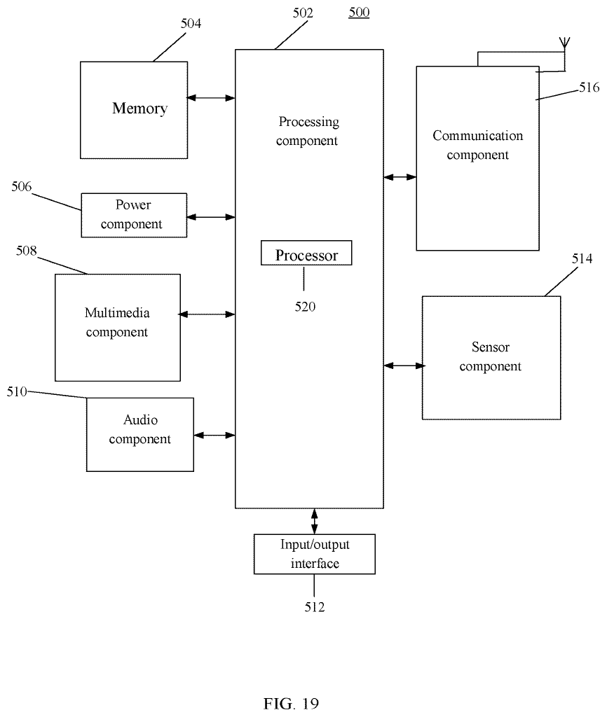

FIG. 19 is a block diagram of an apparatus 500 for communication according to an illustrative embodiment. For example, the apparatus 500 may be a mobile phone, a computer, a digital broadcast terminal, a messaging device, a game console, a tablet device, a medical device, a fitness device, a personal digital assistant, etc.

Referring to FIG. 19, the apparatus 500 may include one or more of the following components: a processing component 502, a memory 504, a power component 506, a multimedia component 508, an audio component 510, an input/output (I/O) interface 512, a sensor component 514, and a communication component 516.

The processing component 502 generally controls the overall operation of the apparatus 500, such as operations associated with display, phone calls, data communications, camera operations, and recording operations. The processing component 502 may include one or more processors 520 to execute instructions to complete all or part of the steps of the above methods. In addition, the processing component 502 may include one or more modules to facilitate interaction between the processing component 502 and other components. For example, the processing component 502 may include a multimedia module to facilitate the interaction between the multimedia component 508 and the processing component 502.

The memory 504 is configured to store various types of data to support operations on the apparatus 500. Examples of such data include instructions for any application or method operating on the apparatus 500, contact data, phone book data, messages, pictures, videos, etc. The memory 504 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 506 provides power to various components of the apparatus 500. The power component 506 may include a power management system, one or more power supplies, and other components associated with generating, managing, and distributing power to the apparatus 500.

The multimedia component 508 includes a screen that provides an output interface between the apparatus 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touch, slide, and other gestures on the touch panel. The touch sensor may not only sense boundaries of the touch or slide action, but also detect the duration and pressure associated with the touch or slide operation. In some embodiments, the multimedia component 508 includes a front camera and/or a rear camera. When the apparatus 500 is in an operating mode, such as a shooting mode or a video mode, the front camera and/or the rear camera may receive external multimedia data. Each of the front camera and rear camera may be a fixed optical lens system or have a focal length and optical zoom capability.

The audio component 510 is configured to output and/or input audio signals. For example, the audio component 510 includes a microphone (MIC), and when the apparatus 500 is in an operating mode, such as a call mode, a recording mode, and a speech recognition mode, the microphone is configured to receive an external audio signal. The received audio signal can be further stored in the memory 504 or sent via the communication component 516. In some embodiments, the audio component 510 also includes a speaker for outputting audio signals.

The I/O interface 512 provides an interface between the processing component 502 and peripheral interface modules, such as a keyboard, a click wheel, buttons, etc. These buttons may include but are not limited to: a home button, a volume button, a start button, and a lock button.

The sensor component 514 includes one or more sensors for providing status assessment of various aspects for the apparatus 500. For example, the sensor component 514 can detect the open/closed state of the apparatus 500, the relative positioning of components, such as the display and keypad of the apparatus 500, and the sensor component 514 can also detect change in the position of the apparatus 500 or a component of the apparatus 500, the presence or absence of user contact with the apparatus 500, the orientation or acceleration/deceleration of the apparatus 500, and change in the temperature of the apparatus 500. The sensor component 514 can include a proximity sensor configured to detect the presence of a nearby object without any physical contact. The sensor component 514 can also include an optical sensor, such as a CMOS or CCD image sensor, for use in imaging applications. In some embodiments, the sensor component 514 can also include an acceleration sensor, a gyroscope sensor, a magnetic sensor, a pressure sensor, or a temperature sensor.

The communication component 516 is configured to facilitate wired or wireless communication between the apparatus 500 and other devices. The apparatus 500 can access a wireless network based on a communication standard, such as Wi-Fi, 2G, 3G, or a combination thereof. In an illustrative embodiment, the communication component 516 receives a broadcast signal or broadcast-related information from an external broadcast management system via a broadcast channel. In an illustrative embodiment, the communication component 516 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

In an illustrative embodiment, the apparatus 500 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an illustrative embodiment, a non-transitory computer-readable storage medium including instructions is also provided, such as the memory 504 including instructions, and the instructions can be executed by the processor 520 of the apparatus 500 to perform the above methods. For example, the non-transitory computer-readable storage medium can be a ROM, a random access memory (RAM), a CD-ROM, a magnetic tape, a floppy disk, an optical data storage device, etc.

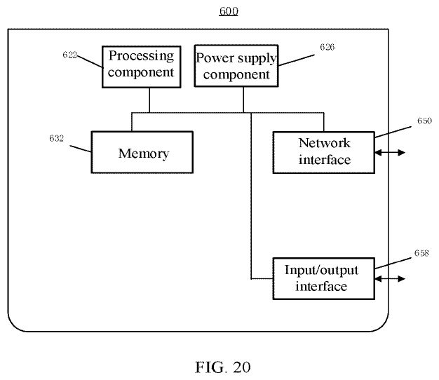

FIG. 20 is a block diagram of an apparatus 600 for communication according to an illustrative embodiment. For example, the apparatus 600 may be provided as a server. Referring to FIG. 20, the apparatus 600 includes a processing component 622, which further includes one or more processors, and a memory resource represented by a memory 632 for storing instructions executable by the processing component 622, such as an application. The application stored in the memory 632 may include one or more modules, each of which corresponds to a set of instructions. In addition, the processing component 622 is configured to execute instructions to perform the above communication methods.

The apparatus 600 may also include a power supply component 626 configured to perform power management of the apparatus 600, a wired or wireless network interface 650 configured to connect the apparatus 600 to a network, and an input/output (I/O) interface 658. The apparatus 600 may operate based on an operating system stored in the memory 632, such as Windows Server™, Mac OS X™, Unix™, Linux™, FreeBSD™, or the like.

It is further understood that in the present disclosure, “multiple” refers to two or more than two, and other quantifiers are similar thereto. “And/or” describes the association relationship of associated objects, indicating that three relationships may exist. For example, A and/or B may represent three situations: A exists alone, A and B exist at the same time, and B exists alone. The character “/” generally indicates that the associated objects before and after this character are in an “or” relationship. The singular forms of “a”, “the” and “said” are also intended to include the plural forms, unless the context clearly indicates otherwise.

It is further understood that the terms “first”, “second”, etc. are used to describe various information, but such information should not be limited to these terms. These terms are only used to distinguish the same type of information from each other, and do not indicate a specific order or degree of importance. In fact, the expressions of “first”, “second”, etc. can be used interchangeably. For example, without departing from the scope of the present disclosure, the first information can also be referred to as the second information, and similarly, the second information can also be referred to as the first information.

It is further understood that, although the operations are described in a specific order in the drawings in the embodiments of the present disclosure, it should not be understood as requiring the operations to be performed in the specific order shown or in a serial order, or requiring performing all the operations shown to obtain the desired results. In certain environments, multitasking and parallel processing may be advantageous.

Those skilled in the art will readily appreciate other embodiments of the present disclosure after considering the specification and practicing the present disclosure disclosed herein. The present disclosure is intended to cover any modifications, uses or adaptations of the present disclosure, which follow the general principles of the present disclosure and include common knowledge or customary technical means in the art that are not disclosed in the present disclosure.

It should be understood that the present disclosure is not limited to the precise structures that have been described above and shown in the drawings, and that various modifications and changes may be made without departing from the scope thereof. The scope of the present disclosure is limited only by the scope of the appended claims.

1. A communication method, applied to a terminal, the method comprising:
in response to monitoring that inference performance of an artificial intelligence (AI) model decreases during communication of the terminal in an AI mode and the inference performance of the AI model decreases to meet a preset condition, switching to a non-AI mode for communication.

2. The method according to claim 1, wherein the method further comprises:
sending a switching request to a network device, wherein the switching request is used to request switching to the non-AI mode for communication.

3. The method according to claim 2, wherein switching to the non-AI mode for communication comprises:
receiving a switching confirmation instruction fed back by the network device based on the switching request; and
switching to the non-AI mode for communication based on the switching confirmation instruction.

4. The method according to claim 3, wherein switching to the non-Al mode for communication based on the switching confirmation instruction comprises:
in response to receiving the switching confirmation instruction sent by the network device, switching to the non-AI mode for communication.

5. The method according to claim 3, wherein switching to the non-AI mode for communication based on the switching confirmation instruction comprises:
after a set time unit from receipt of the switching confirmation instruction sent by the network device, switching to the non-AI mode for communication.

6. The method according to claim 2, wherein sending the switching request to the network device comprises:
sending the switching request to the network device based on a dedicated communication resource;
wherein the dedicated communication resource is a communication resource dedicated to requesting switching from the Al mode to the non-AI mode for communication.

7. The method according to claim 6, wherein the dedicated communication resource comprises a physical random access channel (PRACH) resource dedicated to mode switching.

8. The method according to claim 7, wherein sending the switching request to the network device based on dedicated communication resource comprises:
sending the switching request to the network device based on the PRACH resource using a two-step random access method or a four-step random access method.

9. The method according to claim 8, wherein in response to sending the switching request using the two-step random access method, the switching confirmation instruction fed back by the network device based on the switching request is received based on a physical downlink control channel (PDCCH) or a physical downlink shared channel (PDSCH) corresponding to message B; or
in response to sending the switching request using the four-step random access method, the switching confirmation instruction fed back by the network device based on the switching request is received based on a physical downlink control channel (PDCCH) or a physical downlink shared channel (PDSCH) corresponding to message 2 or message 4.

10. The method according to claim 7, wherein switching to the non-Al mode for communication comprises:
in response to that he terminal completes random access based on the PRACH resource, switching to the non-AI mode for communication after a set time unit from completion of the random access.

11. The method according to claim 6, wherein the dedicated communication resource comprises a physical uplink control channel (PUCCH) resources dedicated to mode switching by the terminal.

12. The method according to claim 11, wherein the switching confirmation instruction fed back by the network device based on the switching request is received based on a physical downlink control channel (PDCCH).

13. The method according to claim 11, wherein switching to the non-Al mode for communication comprises:
in response to that the terminal completes PUCCH transmission based on the PUCCH resources, switching to the non-AI mode for communication after a set time unit from completion of the PUCCH transmission.

14. The method according to claim 1, wherein the preset condition comprises at least one of the following conditions:
a rate of decrease of the inference performance of the AI model exceeds a rate threshold;
an accuracy of the inference performance of the AI model is lower than an accuracy threshold; or
an operating performance of an inference object applying the Al model meets a preset performance condition.

15-19. (canceled)

20. A communication method, applied to a network device, the method comprising:
sending a switching request sent by a terminal, wherein the switching request is triggered in a case where the terminal monitors that inference performance of an artificial intelligence (Al) model decreases during communication of the terminal in an Al mode and the inference performance of the AI model decreases to meet a preset condition, and the switching request is used to request switching to a non-AI mode for communication.

21. The method according to claim 20, wherein receiving the switching request sent by the terminal comprises:
receiving the switching request sent by the terminal based on a dedicated communication resource;
wherein the dedicated communication resource is a communication resource dedicated to requesting to switch from the Al mode to the non-AI mode for communication.

22. The method according to claim 21, wherein the dedicated communication resource comprises a physical random access channel (PRACH) resource dedicated to mode switching, wherein receiving the switching request sent by the terminal based on the dedicated communication resource comprises:
receiving the switching request sent by the terminal based on the PRACH resource using a two-step random access method or a four-step random access method.

23-24. (canceled)

25. The method according to claim 21, wherein the method further comprises:
feeding back a switching confirmation instruction to the terminal, wherein in response to that the switching request is sent using a two-step random access method, the switching confirmation instruction is fed back to the terminal based on a physical downlink control channel (PDCCH) or a physical downlink shared channel (PDSCH) corresponding to message B; or
in response to that the switching request is sent using a four-step random access method, the switching confirmation instruction is fed back to the terminal based on a physical downlink control channel (PDCCH) or a physical downlink shared channel (PDSCH) corresponding to message 2 or message 4.

26-33. (canceled)

34. A communication apparatus, comprising:
a processor; and
a memory configured to store instructions executable by the processor:
wherein the processor is configured to, in response to monitoring that inference performance of an artificial intelligence (AI) model decreases during communication of a terminal in an AI mode and the inference performance of the AI model decreases to meet a preset condition, switch to a non-AI mode for communication.

35-37. (canceled)

38. A communication apparatus, comprising:
a processor; and
a memory configured to store instructions executable by the processor;
wherein the processor is configured to execute the communication method according to claim 20.

39. (canceled)
